(19) United States
(12) Patent Application Publication
(10) Pub. No.: US 2011/0000245 A1
(43) Pub. Date: Jan. 6, 2011

(54) ABSORPTION MACHINE HAVING A BUILT-IN ENERGY STORAGE WORKING ACCORDING TO THE MATRIX METHOD

(75) Inventor: Goran Bolin, Taby (SE)

Correspondence Address: HOLLAND & HART, LLP, P.O BOX 8749, DENVER, CO, 80201, US

(73) Assignee: Climatewell AB (Publ), Hagersten (SE)

(21) Appl. No.: 12/812,090

(22) PCT Filed: Feb. 10, 2009
(86) PCT No.: PCT/SE09/50136

§ 371 Date: Sep. 15, 2010

(30) Foreign Application Priority Data
Feb. 12, 2008 (SE) 0800314-7

(51) Int. Cl. F25B 17/08; F28D 20/02; F25B 30/04; C09K 5/06

(52) U.S. Cl. 62/324.2; 165/104.17

(57) ABSTRACT

In a chemical heat pump using a hybrid substance (2) and a volatile liquid, layers (3) of a matrix material are provided for binding or containing the substance and/or the condensed volatile liquid. These matrix layers are placed sot that transport of heat to or from an external medium at at least the free surfaces of the matrix layers is obtained and preferably also at their opposite surfaces. Therefor, pipe conduits (9) are provided, in which the external medium flows and which are placed at the surfaces of the matrix layers, such as both beneath supporting plates (4) and directly on top of the matrix layers. By using pipe conduits at the free surfaces of the matrix layers, i.e. the surfaces which are not located at the supporting plates, it is achieved that the free surfaces of the matrix layers still are permeable to the vapour of the volatile liquid in both the evaporation stage and the condensing stage.

### RELATED APPLICATION

This application claims priority and benefit from Swedish patent application No. 0800314-7, filed Feb. 12, 2008, the entire teachings of which are incorporated herein by reference.

### TECHNICAL FIELD

The present invention relates to an absorption machine having a built-in energy storage working according to the matrix method.

### BACKGROUND

In an absorption machine working according to the “matrix method” described in the published International patent application WO 2007/139476 a carrier, a “matrix”, for the active substance is used that from a solid state in the discharging stage absorbs vapour of a volatile liquid and thereby takes a liquid state and thereafter, in the charging stage, releases the vapour. The matrix is placed in tight contact with a substantially flat wall of a more or less well heat conducting material, for example a metal or glass, through which heat exchange with the active substance occurs.

Then, there exists a problem relating to the heat exchanging process, i.e. the heat exchange between the active substance, and an external medium located on the other side of said wall. It appears that the matrix material is itself an isolating material that can obstruct the desired exchange of heat through the heat exchanging wall and the matrix material. Furthermore, in order that an absorption machine working according the matrix method will be capable of providing a good power and efficiency and a desired output energy, the active surface of the matrix, where the active substance is arranged, should have a temperature that is a similar as possible to the temperature of the medium on the other side of the wall or at least is as similar as possible to the temperature that the wall itself has. In the case where the difference is too large, it may happen that the absorption machine, neither in its heating state nor in its cooling state, can deliver the desired high temperature or the desired low temperature, respectively.

Furthermore, for the power output from the absorption machine in its heating state and in its cooling state, respectively, the amount of energy per time unit, i.e. the power that can travel from the surface of the heat exchanging wall to the active surface of the matrix, is important. It is, as has been indicated above, dependent on the thermal conductivity of the matrix material. As the matrix material is porous and often includes ceramics having a low thermal conductivity, the matrix material has, in particular during the times when it is not entirely soaked with liquid, in itself a low thermal conductivity and resembles ordinary heat insulating materials as to the thermal conducting properties thereof.

As has been mentioned earlier, it is desired to achieve that the active matrix surface has the same temperature as the temperature of the heat exchanging wall, and then it is near at hand to find that it would be suitable to arrange a direct heating by placing the heat exchanging surface in direct contact with the surface of the active matrix. However, it is impossible since in that case the heat exchanging surface would be blocking, obstructing the evaporation of water to water vapour from the active surface of the matrix and the condensation of vapour to water in the surface of the matrix, these two processes forming the very basis of the function of the absorption machine and corresponding to the two stages of operation, i.e. the charging stage and the discharging stage.

### SUMMARY

It is an object of the invention to provide a chemical heat pump comprising a hybrid substance that uses matrix layers for containing/binding an active substance and/or a condensate and has an efficient transport of heat to and from such layers.

Thus, matrix layers containing for example active substance can be placed, so that transport of heat to and from an external medium at at least the free surfaces of the active substance is obtained. The heat exchange can also occur at those surfaces of the layers which are opposite the free surfaces. It can be obtained by the fact that pipe conduits through which the external medium is flowing are placed at the surfaces of the layers, such as both under supporting plates and directly on top of the layers. By in particular using pipe conduits at the free surfaces of the layers, i.e. the surfaces, which are not located at the supporting plates, it is obtained that the free surfaces of the layers still are permeable to vapour both in the evaporation stage and the condensing stage.

Thereby, an efficient transport of heat and an efficient structure of the containers in the chemical heat pumps can be achieved.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIGS. 1a and 1b are schematics as seen from the side and from the top of a segment of a matrix layer placed on a supporting plate,

FIGS. 2a and 2b are similar to FIGS. 1a and 1b but with a matrix layer including a net structure applied thereto, and

FIG. 3 is a schematic of a chemical heat pump working according to the hybrid principle and including an active substance sucked into a carrier.

### DETAILED DESCRIPTION

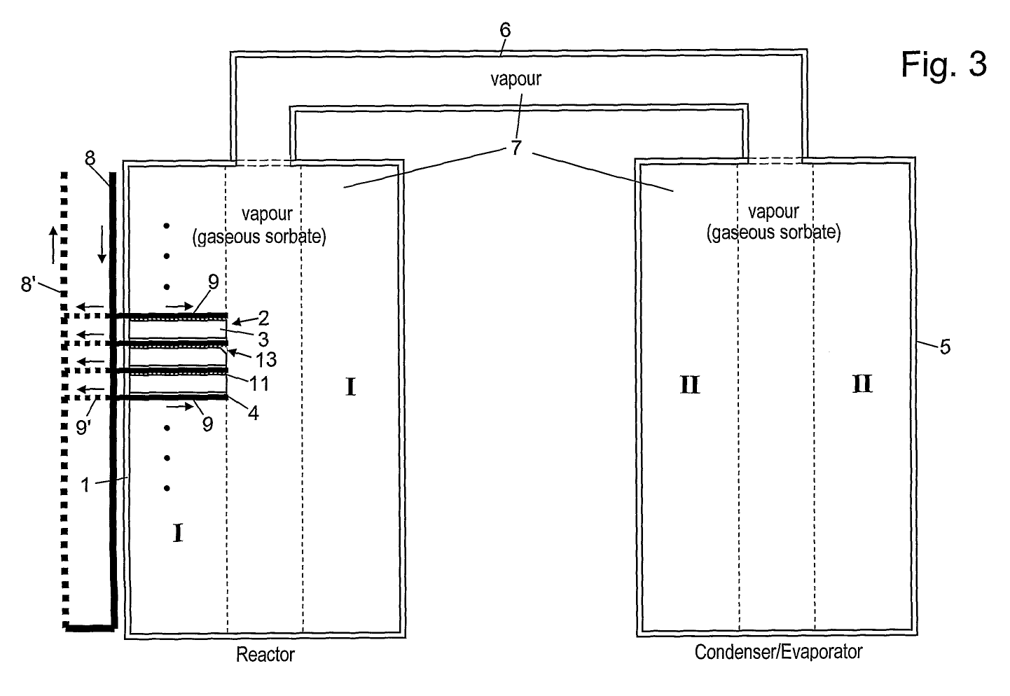

In the chemical heat pump schematically illustrated in FIG. 3 a first container 1 is provided, also called accumulator or reactor, containing an active substance 2, also called only “substance” herein. The substance can exothermically absorb and endothermically desorb a sorbate that generally is a volatile liquid and usually is water. The substance 2 is here shown to be held or carried by or sucked into a matrix or carrier 3 that generally forms or has the shape of as at least one porous body having open pores and being made from a suitable inert substance, see the above cited International patent application. The matrix can as illustrated by arranged as horizontal layers having a uniform or substantially constant thickness on a plurality of plates 4 that are located one above another and extend from the inner wall of the reactor container 1 towards the inner of this container. The plates can for example project from two opposite parallel inner surfaces of the container. The first container 1 is connected to a second container 5, also called condenser/evaporator, through a fixed gas conduit 6 having the shape of a pipe connected to the two containers 1, 5. The second container acts as a condenser for condensing gaseous sorbate 7 to liquid sorbate 8 during endothermical desorption of substance 2 in the first container 1 and as an evaporator of liquid sorbate 8 to gaseous sorbate 7 during exothermical absorption of sorbate in the substance in the first container.

For a heat pump working according to the hybrid principle, the active substance and the volatile liquid are selected sot that the volatile liquid can be absorbed by the active substance at a first temperature and be desorbed by the active substance at a second, higher temperature. The active substance must at the first temperature have a solid state, from which the active substance when absorbing the volatile liquid and the vapour phase thereof immediately partially passes to a liquid state or a solution phase and at the second temperature the active substance must have a liquid state or exist in a solution phase, from which the active substance, when releasing the volatile liquid, in particular the vapour phase thereof, immediately partly passes to a solid state,

The active substance 2 located in the layers 3 of matrix in the accumulator 1 must for the function of the heat pump be in heat exchanging contact with an external medium. This medium can be provided through an outer pipe conduit 8 having branches 9 passing into the inner of the accumulator. The branch conduits can be placed partly under the plates 4, partly at the top sides or top surfaces of the matrix layers 3. As illustrated in the figures, in particular the branch conduits 9 placed at the free surface of the matrix layers 3 can be arranged in a more or less sparse fashion, leaving between the conduits non-blocked areas of said free surfaces where the transport of vapour is unobstructed by the conduits. Thus, the pipe portions located at the free surface can e.g. cover only a minor portion of the free surfaces, e.g. less than 50% of the free surface areas. It ensures that the transport of vapour to and from the active substance in the matrix layers can occur freely. Such a design having an efficient heat exchange can allow the use of matrix layers 3 having a larger thickness, for example having a thickness of 20-30 mm, compared to the thicknesses of 5-10 mm described in the cited International patent application.

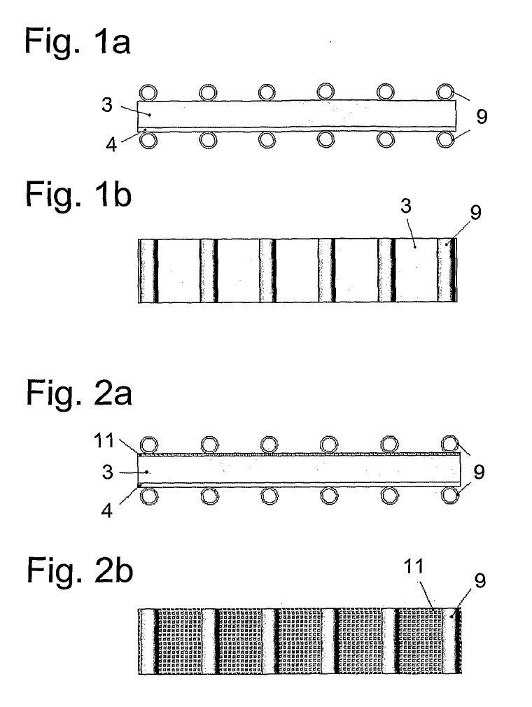

The arrangement of the branch conduits 9 is also illustrated in FIGS. 1a and 1b. It is seen that the portions of the pipe conduits 9 that are located at a side of a matrix layer can comprise pipe segments that are parallel to each other and arranged regularly, at a uniform distance of one another. As illustrated, the uniform distance can be significantly larger than the diameter of the pipes in the segments, e.g. be more than twice said diameter or even more than three times said diameter. Furthermore, in FIG. 1a it is illustrated how the pipe conduits 9 can be placed under and on top of a matrix layer 3, so that a first loop of the pipe conduit passes at the free surface of each matrix layer and a second loop of the pipe conduit under the plate, on which the considered matrix layer rests. The pipe conduits in the loops can extend in parallel to each other, for example having the shape of a zigzag path, this case not being shown, however.

It also appears from FIGS. 2a and 2b that the heat exchange at the top side of the layer 3 can be further increased by the fact that this layer is covered with a structure having openings such as a net 11. Generally, the total area of the openings should correspond to a sufficient share of the total area of the free surface of the matrix layer, e.g. more than 50%. The covering structure can be made from some material having a good thermal conductivity, for example a metal such as copper.

The compact design is further apparent from FIG. 3. The heat exchanging medium enters the pipe conduit 8 and passes into the branch conduits 9. A zigzag-arrangement of the branch conduits is provided in the space between each matrix layer 3 and the plate 4 placed above it, so that the thickness of the pipe conduit layers substantially fills this interspace, i.e. the diameter of the pipes used can substantially correspond to the thickness of the intermediate space. In this case, thus, the above mentioned first loop of the pipe conduit 9 for a considered matrix layer 3 is at the same the second loop of the pipe conduit for a next matrix layer located directly above the considered matrix layer. Additionally, it may in this case be required that special arrangements are made at the centre of the container 1, where the branch conduits are bent back to make the medium flow in the opposite direction, so that the bent portions of the branch conduits 9 do not obstruct the flow of vapour into and from the intermediate spaces. For example, as is shown at 13 an edge region of the matrix layer can be removed, at the top inner edge of the matrix layer 3. The matrix layer can then be said to bevelled at the top inner edge. The removed edge region can as illustrated have an approximately triangular cross-section. The medium is returned to the return portion 8′ of the supply conduit 8 through branch conduit portions shown as the dashed lines 9′.

A set of parallel plates 4, matrix layers 3 and branch conduits 9 arranged at the matrix layers can as indicated in FIG. 3 be provided within regions I at two opposite walls of the reactor 1. The same structure can be used in the condenser/evaporator 5, where in that case the matrix layers 3 do not contain and do not bind active substance but instead contain and/or bind condensed sorbate. Plates 4 and layers 3 are then arranged in the regions II. The branch conduits are here connected to pipes, not shown, for another heat exchanging medium. This structure can alternatively be used in only one of the containers 1, 5 in the case where the other container for some reason must be constructed in another way.

While specific embodiments of the invention have been illustrated and described herein, it is realized that numerous other embodiments may be envisaged and that numerous additional advantages, modifications and changes will readily occur to those skilled in the art without departing from the spirit and scope of the invention. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention. Numerous other embodiments may be envisaged without departing from the spirit and scope of the invention.

1. A chemical heat pump comprising an active substance and a volatile liquid that can be absorbed by the active substance at a first temperature and be desorbed by the active substance at a second, higher temperature, the active substance at the first temperature having a solid state, from which the active substance when absorbing the volatile liquid and the vapour phase thereof immediately partially passes to a liquid state or a solution phase and at the second temperature has a liquid state or exists in a solution phase, from which the active substance, when releasing the volatile liquid, in particular the vapour phase thereof, immediately partly passes to a solid state, comprising:
a first container containing the active substance,
a second container contained the portion of the volatile liquid that exists in a condensed form, and
a channel for the vapour phase of the volatile liquid, the channel interconnecting the first container and the second container,
characterized in that at least one of the first and second containers comprises layers of a matrix material to receive the active substance or the portion of the volatile liquid, that exists in a condensed form, respectively, that the matrix layers are placed in direct contact with fixed surfaces of the respective container and that for heat exchange with an external medium first pipe conduits for the external medium pass directly at the free surface of the matrix layers which are opposite those surfaces of the layers at which the matrix layers are in contact with the fixed surfaces of the container.

2. A chemical heat pump according to claim 1, characterized in that supporting plates are arranged in said at least one of the first and second containers, the supporting plates extending from an outer wall of the container towards the interior of the container.

3. A chemical heat pump according to claim 1, characterized in that supporting plates extending substantially horizontally are arranged in said at least one of the first and second containers and that the matrix layers are arranged on top of the supporting plates.

4. A chemical heat pump according to claim 2, characterized in that for heat exchange with the external medium also second pipe conduits for the external medium are provided which pass directly at surfaces of the supporting plates with which no matrix layer is in contact.

5. A chemical heat pump according to claim 1, characterized in that the first pipe conduit for a matrix layer at the same time is the second pipe conduit for a next matrix layer placed at the free surface of the considered matrix layer.

6. A chemical heat pump according to claim 1, characterized in that heat distributing covering structures having openings, in particular nets, are arranged between the free surfaces of the matrix layers and the first pipe conduits.

7. A chemical heat pump according to claim 2, characterized in that supporting plates extending substantially horizontally are arranged in said at least one of the first and second containers and that the matrix layers are arranged on top of the supporting plates.

8. A chemical heat pump according to claim 3, characterized in that for heat exchange with the external medium also second pipe conduits for the external medium are provided which pass directly at surfaces of the supporting plates with which no matrix layer is in contact.

9. A chemical heat pump according to claim 2, characterized in that the first pipe conduit for a matrix layer at the same time is the second pipe conduit for a next matrix layer placed at the free surface of the considered matrix layer.

10. A chemical heat pump according to claim 3, characterized in that the first pipe conduit for a matrix layer at the same time is the second pipe conduit for a next matrix layer placed at the free surface of the considered matrix layer.

11. A chemical heat pump according to claim 4, characterized in that the first pipe conduit for a matrix layer at the same time is the second pipe conduit for a next matrix layer placed at the free surface of the considered matrix layer.
